(19) United States
(12) Patent Application Publication
(10) Pub. No.: US 2009/0308622 A1
(43) Pub. Date: Dec. 17, 2009

(54) Fire Protection System for One or More Supply Lines

(75) Inventors: Jörg Hansen, Lohfelden (DE); Alexander Reim, Jühnde (DE)

Correspondence Address: PYLE & PIONTEK, LLC, 221 N LASALLE STREET , ROOM 1207, CHICAGO, IL, 60601, US

(73) Assignee: AIK Flammadur Brandschutz GmbH, Kassel (DE)

(21) Appl. No.: 11/795,370

(22) PCT Filed: Jul. 21, 2006
(86) PCT No.: PCT/DE2006/001274

§ 371 Date: Jul. 16, 2007

(30) Foreign Application Priority Data
Jul. 21, 2005 (DE) 10 2005 033 991.3

(51) Int. Cl. A62C 3/00

(52) U.S. Cl. 169/54

(57) ABSTRACT

The fire protection system is for two or more supply lines (10), especially supply lines (10) mounted on a route (16) or a rack (18). The supply lines (10) are entirely surrounded by an isolating layer (12) made of a non-flammable or hardly combustible insulating material while a hollow space (15) is embodied between the supply lines (10) and the isolating layer (12). An insulating layer (14, 24) comprising an intumescent insulating layer-forming agent or an ablation is applied to the inside and/or outside of the isolating layer (12) to create a fire protection system for supply lines which ensures sufficient functionality of the supply lines even when space is limited.

The present invention relates to a fire protection system according to the preamble of the claims 1, 2 and 6.

In the construction of ships, vehicles, aircrafts and buildings, supply lines (electric cables, data cables, pipes or the like) need to be well insulated in order to achieve effective fire protection. For this purpose, several supply lines are combined into a run and/or disposed on a tray. Various systems are known according to which a fire-barrier layer forming agent is applied either directly onto the supply line or onto the run carrying the supply line. This fire-barrier layer forming agent foams up to many times its coating thickness as soon as it comes into contact with heat (about 80° C.-140° C.), this foam being a very poor heat conductor, thus providing good protection against heat and flames. The fire-barrier layer forming agent is applied so that the dry coating thickness is about 1 mm-2 mm, which means that it needs very little space.

In other systems, an ablation is applied directly onto the supply line or onto the run carrying the supply line. This ablation may be configured to form a crust, to insulate, to cool or to extinguish on its own. The ablation also is only effective at a temperature of at least 80° C. and is also applied so that the dry coating thickness is about 1 mm-2 mm thus also only needing very little space and being even less expensive than a fire-barrier layer forming agent.

Below their reaction temperature of at least 80° C., the intumescent and/or ablative fire-barrier layer forming agents hardly have any insulating effect so that, when the fire-barrier layer forming agent is enabled, the supply line already is at a temperature of 80° C. as well. This is a problem with electric cables or data cables for example since the functional efficiency of these cables decreases at 80° C., in particular if these cables are exposed for a longer period of time to a temperature of 80° C. or of approximately 80° C.

In order to avoid this effect, other systems propose to sheath the supply lines with a noncombustible insulating material such as mineral wool, a glass fiber mat, foam glass, Armaflex or a hardly flammable insulating material, for example with a PU foam material, a cast, injection-moulded, vulcanized or extruded foam material, with polyether, polyester, polyamide foam or with a foamed plastic material. All these insulation materials are poor heat conductors and retard heating of the supply lines for a length of time that depends on the thickness of the insulating material.

In order to make certain that the function of the supply line is sufficiently preserved in the event of a fire, the applied coating thickness of the insulating material must be very high, at least 80 mm, better 200 mm, this provision requiring lots of space, implying high weight and causing high costs.

Heat insulation however only comes into effect once a critical temperature has been reached below which the heat insulating performance of the fire-barrier layer forming agent is negligible. The fire-barrier layer forming agent may thereby be foaming or compressing (e.g., swell pressure) and/or be adjusted in such a manner that the critical temperature is about 80° C. By nature, the life of such a fire-barrier layer forming agent is very short so that it must be exchanged after only a few years, which is very cost intensive in the construction of buildings or ships in particular. If the fire-barrier layer forming agent is adjusted to have a critical temperature of 140° C., its life is very much improved so that it may be utilized much longer with the follow-up costs getting much lower.

In view thereof, it is the object of the present invention to provide a fire protection system for supply lines that makes certain that the function of supply lines is sufficiently preserved, even in space restricted applications. Advantageously, the fire protection system is intended to have a long life.

The technical solution to this problem proposed by the invention is a fire protection system having the features of claim 1, of claim 2 or of claim 6. Advantageous developed implementations of this fire protection system are respectively recited in the dependent claims.

A fire protection system configured in accordance with this technical teaching in which the fire-barrier layer is applied to the outside of the insulation layer has the advantage that heat generated in the event of a fire is retarded by the fire-barrier layer (both by an intumescent and by an ablative fire-barrier layer) so that the insulation layer will only heat up slowly. Thanks to the insulation layer, heat transfer is further delayed so that the supply line heats up slowly in accordance thereto and that the function of the supply line is preserved accordingly. Since one of the functions of the insulation layer is to effect heating of the supply line in a temperature range below the enabling temperature of the fire-barrier layer forming agent, it may be configured to be much thinner than in prior art so that the fire protection system of the invention needs only little space and is relatively light weighted thanks to the combination of insulating material with an intumescent or ablative fire-barrier layer having good insulating properties applied to the outside thereof so that the design of the carrier systems of the run may also be smaller and less expensive.

A fire protection system configured in accordance with this technical teaching in which the fire-barrier layer is applied to the inside of the insulation layer has the advantage that the material of the insulation layer already has a heat insulating effect at low temperatures so that the critical temperature at the fire-barrier layer forming agent (intumescent or ablative fire-barrier layer forming agent) is reached much later so that it also foams up much later. As a result, the function of the supply lines is preserved for a much longer period of time.

Another advantage is that the supply lines reach the critical temperature of e.g., 80° C. only much later so that the cables beneath the supply lines are exposed to the temperature of 80° C. for an accordingly shorter period of time. By the way, this embodiment also has the already mentioned advantage that the fire-barrier layer needs only little space while exhibiting good insulation properties and that it is relatively light weighted so that the design of the carrier systems of the run may be smaller and less expensive.

A fire protection system configured in accordance with this technical teaching in which the fire-barrier layer is applied inside and outside of the insulation layer has the advantage of cumulating the afore mentioned advantages. This means that in this case, to insulate the supply line in the event of fire, a relatively light-weighted and space-saving fire-barrier layer forming agent is utilized in combination with an insulation layer made for example of mineral wool in order to achieve a lighter weighted and more space-saving fire protection system while keeping the same insulation effects.

Another advantage is that, if the fire-barrier layer is applied inside and outside, at least the fire-barrier layer applied on the outside may be adjusted to a slightly higher enabling temperature of T=T1+T2. Taking into consideration that in the event of a fire the temperatures are much higher than the enabling temperature T and that, thanks to the insulation layer, it takes a certain time for the inner fire-barrier layer to reach the critical temperature T1, it is suffices, in order to preserve the function, to enable the outer fire-barrier layer before the inner fire-barrier layer has reached the enabling temperature T1. The advantage thereof is that the outer fire-barrier layer is given a higher durability before it must be replaced due to aging. The inner fire-barrier layer has a longer life anyway since it is not or not so strongly exposed to environmental impacts. As a result, such a fire protection system has an increased durability, which brings a cost saving for the user.

The use of a fire-barrier layer forming agent applied to the inside for insulating a bundle of supply lines further has the advantage that in the event of an internal fire, such as a cable fire, the foaming fire-barrier layer forming agent fills out the cavities about the supply lines, thus extinguishing the fire. Another advantage is that this also allows preventing or stopping smoke formation since all the cavities are now closed by the foamed fire-barrier layer forming agent and since the smoke is allowed neither to form nor to propagate for the least.

Still another advantage of the fire protection system of the invention is that in some cases the insulation effect of the safety layer suffices for the critical temperature not to be reached. In this case, the fire-barrier layer forming agent is not activated so that no costs are incurred for producing the fire-barrier layer forming agent anew.

One distinguishes fire protection systems according to their field of application. Fire protection systems configured in the form of I channels for example are suited for not allowing heat or fire to pass from the inside to the outside whereas fire protection systems configured to be E channels are not allowed to let heat or fire pass from the outside to the inside.

A fire protection system implemented in accordance with this technical teaching has the advantage that it may be utilized both as I channel and as E channel despite of its small size since the heat generation is efficiently prevented in both directions so that in both cases long operability is ensured.

In an advantageous embodiment, another insulation layer is applied to the external fire-barrier layer so that the fire-barrier layer is interposed between two insulation layers.

It has been found out that it is advantageous to interpose the fire-barrier layer between two insulation layers not only in the case of bundles of supply lines but also in case of individual supply lines.

The above mentioned advantages are also achieved by having the fire-barrier layer disposed in the center of the insulation layer. Another advantage is that heat generated in the event of a fire only reaches the fire-barrier layer forming agent with a delay so that the fire-barrier layer forming agent will not enable each time it is subjected to short-time heating but only in the event it is seriously exposed to fire. This reduces the number of the cases in which the fire-barrier layer forming agent needs to be renewed, this bringing a cost saving.

Another cost saving is achieved in that the fire-barrier layer forming agent is protected against environmental impact by the insulation layer so that aging due to environmental factors is retarded, this leading to increased durability.

Still another advantage is that the insulation layer also offers a certain mechanical protection. In practice, it repeatedly happens that fire protection systems are damaged during erection or reparation of neighbouring installations. Here, the outer insulation layer protects the fire-barrier layer.

Tests showed that a fire protection system having several alternately disposed fire-barrier layers and insulation layers exhibits outstanding protection properties.

In a preferred embodiment, a second fire-barrier layer at least is applied to the first one, said second fire-barrier layer being adapted to comprise another intumescent fire-barrier layer forming agent. This allows for further increasing the fire protection effect.

In an advantageous developed implementation, the insulation layer is at least 10 times, preferably 30 times, thicker than the fire-barrier layer. The advantage thereof is that the fire-barrier layer is already heat-insulated with the consequence that the critical temperature is reached much later.

In still another particularly preferred embodiment, a nonwoven glass or woven glass fabric is provided between the insulation layer and the fire-barrier layer. The advantage thereof is that there may be provided another fire retardant or insulation that occupies little space and is easy to mount.

In still another preferred embodiment, there is provided a layer made from Armaflex. This Armaflex is relatively stable and offers, inter alia, a mechanical protection so that the fire protection system is protected against mechanical load. A line system thus equipped may for example be stepped upon by a worker without being damaged.

Further advantages of the fire protection system of the invention will become apparent in the appended drawings and in the following description of embodiments thereof. Likewise, the invention lies in each and every novel feature or combination of features mentioned above or described herein after. The embodiments discussed herein are merely exemplary in nature and are not intended to limit the scope of the invention in any manner.

In said drawing:

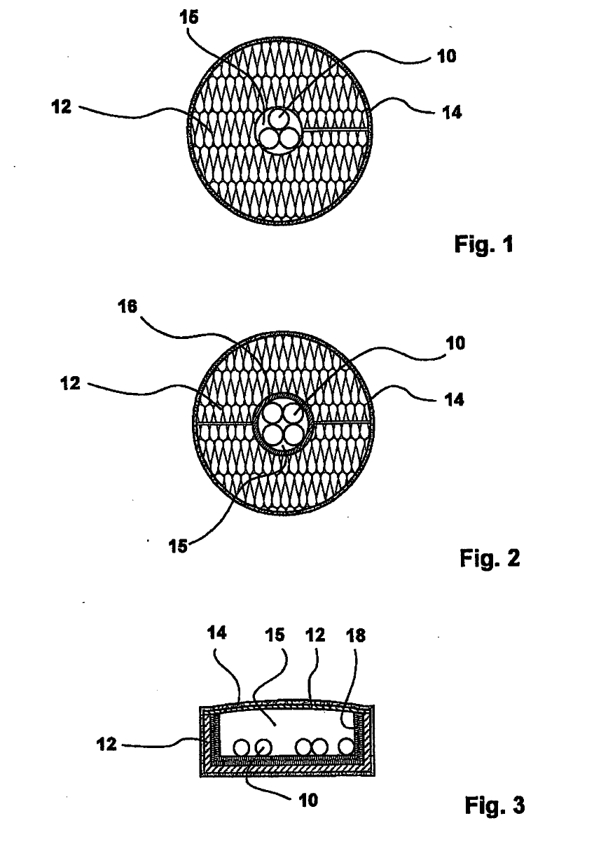

FIG. 1 shows a cross sectional view of a bundle composed of three supply lines with a first embodiment of a fire protection system of the invention;

FIG. 2 shows a cross sectional view of a run with four supply lines with a fire protection system according to FIG. 1;

FIG. 3 shows a cross sectional view of a tray with five supply lines with a fire protection system according to FIG. 1;

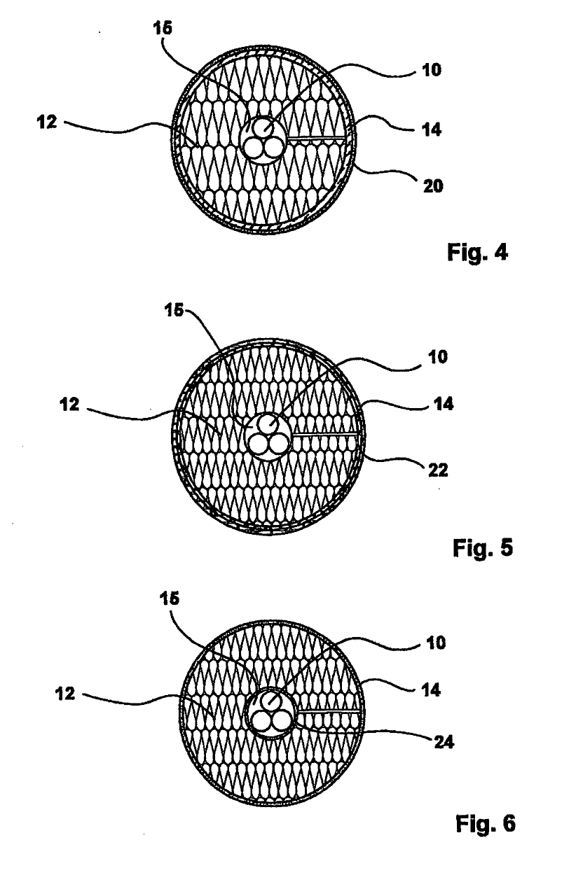

FIG. 4 shows a cross sectional view of a bundle composed of three supply lines with a second embodiment of a fire protection system of the invention;

FIG. 5 shows a cross sectional view of a bundle composed of three supply lines with a third embodiment of a fire protection system of the invention;

FIG. 6 shows a cross sectional view of a bundle composed of three supply lines with a fourth embodiment of a fire protection system of the invention;

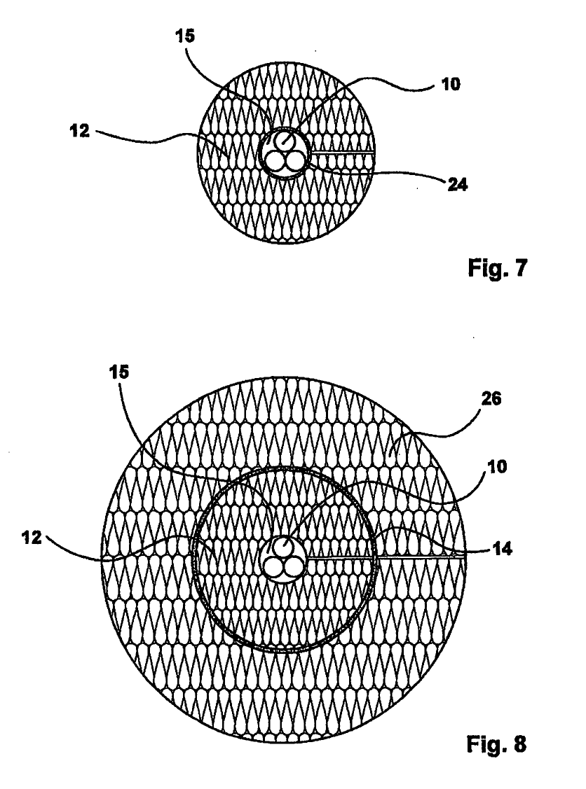

FIG. 7 shows a cross sectional view of a bundle composed of three supply lines with a fifth embodiment of a fire protection system of the invention;

FIG. 8 shows a cross sectional view of a bundle composed of three supply lines with a sixth embodiment of a fire protection system of the invention;

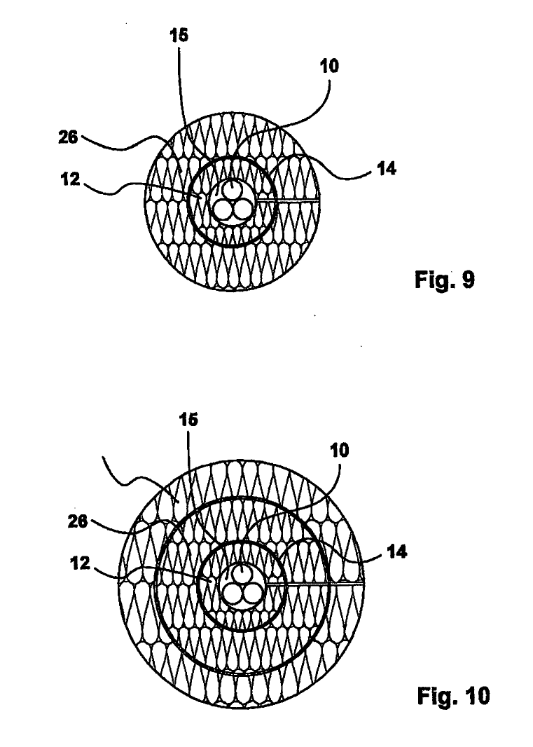

FIG. 9 shows a cross sectional view of a bundle composed of three supply lines with a seventh embodiment of a fire protection system of the invention;

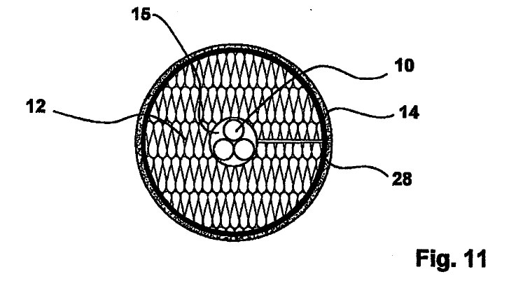

FIG. 10 shows a cross sectional view of a bundle composed of three supply lines with an eighth embodiment of a fire protection system of the invention;

FIG. 11 shows a cross sectional view of a bundle composed of three supply lines with a ninth embodiment of a fire protection system of the invention;

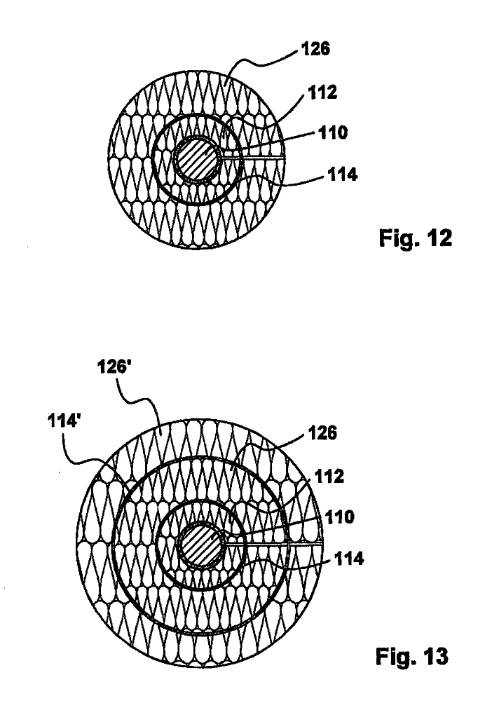

FIG. 12 shows a cross sectional view of a single supply line with a fire protection system of the invention analogous to the seventh embodiment;

FIG. 13 shows a cross sectional view of a single supply line with a fire protection system of the invention analogous to the eighth embodiment.

FIG. 1 shows a first embodiment of a fire protection system of the invention for protecting a bundle of supply lines 10. The supply lines 10 mentioned herein after are understood to refer to electrical cables, data cables, water or gas pipes or other supply lines.

In the embodiment shown in FIG. 1, an insulation layer 12 is disposed about a bundle of three supply lines 10, said insulation layer consisting of a noncombustible or hardly combustible insulation material, a fire-barrier layer 14 made from an intumescent fire-barrier layer forming agent being applied to the outer skin of the insulation layer 12. A fire protection system meeting the requirements of E 90 flammability rating is shown in FIG. 1 and has for example the following structure:

Three supply lines 10 configured in the form of cables are completely wrapped in an insulation layer 12 having a coating thickness of 40 mm. The insulation layer 12 does not fit completely against the supply lines 10 but leaves instead a hollow space 15. The space which is surrounded by the insulation layer 12 and in which the supply lines 10 are guided has a diameter of about 60 mm. On the external side of the insulation layer 12 a fire-barrier layer 14 made from a water based, intumescent fire-barrier layer forming agent is next applied, said fire-barrier layer having a dry coating thickness of about 1 mm.

In this embodiment, the insulation layer 12 is formed from mineral wool although it may also be made from another noncombustible insulation material, such as from mineral wool, from a glass fiber mat, from foam glass, Armaflex or from a hardly flammable insulating material, for example from a PU foam material, a cast, injection-moulded, vulcanized or extruded foam material, from polyether, polyester, polyamide foam or from a foamed plastic material. The fire-barrier layer 14 can be made from a water or solvent based intumescent fire-barrier layer forming agent as it is sold for example by the company AIK Flammadur Brandschutz GmbH under the name A 77 or A 128. The fire-barrier layer forming agent is thereby adjusted to a critical temperature of about 140° C. because this is a temperature at which the fire-barrier layer forming agent has a very long life. In another embodiment, the critical temperature may also be lowered to about 80° C. if in this case of application the fire-barrier layer formed is allowed to have a shorter life.

This embodiment is suited for use as I channel (no heat or fire is allowed to pass from the inside to the outside) since heat generation from the inside to the outside is particularly efficiently prevented. This embodiment is also particularly well suited for use as E channel (no heat or fire is allowed to pass from the outside to the inside) because the heat generated on the fire-barrier layer forming agent is shielded by the insulation layer, at least for a certain period of time.

In an alternative embodiment that has not been illustrated herein, an ablation rather than a fire-barrier layer forming agent is applied onto the insulation layer.

FIG. 2 shows the same fire protection system as in FIG. 1, but here the supply lines 10 are guided in a run 16 surrounding the supply lines 10. The insulation layer 12 made from mineral wool is implemented in two parts in this embodiment in order to achieve improved and faster mounting of the insulation layer 12.

The embodiment shown in FIG. 3 also comprises the same fire protection system, the various supply lines 10 being however disposed on a tray 18 in this case. Here, the tray 18 is surrounded by an insulation layer 12 on its three closed sides and on its open side. A fire-barrier layer 14 made from an intumescent fire-barrier layer forming agent is next applied about the insulation layer 12 and complements the fire protection system.

FIG. 4 shows a second embodiment of a fire protection system of the invention. As contrasted to the fire protection system shown in the FIGS. 1 through 3, a second fire-barrier layer 20 is applied that also has a dry coating thickness of 1 mm. This second fire-barrier layer 20 is made from another fire-barrier layer forming agent, said fire-barrier layer forming agent of the second fire-barrier layer 20 having a critical temperature of 80° C. whilst the fire-barrier layer forming agent of the first fire-barrier layer has a critical temperature of about 140° C. Fire protection is significantly improved as a result thereof, the second fire-barrier layer 20 foaming up first and effecting a good fire protection. It is not until the fire protection effect of the outer fire-barrier layer 20 has worn off that the first fire-barrier layer 14 comes into effect and foams up when subjected to the corresponding heat. As a result, heat is restrained for an even longer period of time.

In an embodiment that has not been illustrated herein, three fire-barrier layers have been applied to the insulation layer in order to even further increase the fire protection effect.

In the third embodiment shown in FIG. 5, a nonwoven glass 22 such as “A 153 Firestop Vlies” of the applicant, which generates an additional heat protection effect, is applied between the insulation layer 12 and the fire-barrier layer 14.

The fourth embodiment illustrated in FIG. 6 differs from the first embodiment shown in FIG. 1 in that a fire-barrier layer 24 is also provided on the inner side of the fire-barrier layer 12. As a result, heat is prevented from building up in the interior by the fact that the hollow space 15 located inside closes when the fire-barrier layer 24 foams up so that heat, smoke or fire is prevented from being transported. This makes it also possible to extinguish a local fire.

The fifth embodiment shown in FIG. 7 differs from the fourth embodiment shown in FIG. 6 by the fact that the fire-barrier layer 24 is disposed on the inner side of the insulation layer 12 whilst no fire-barrier layer is provided on the outer side of the insulation layer 12.

The sixth embodiment shown in FIG. 8 differs from the first embodiment shown in FIG. 1 by the fact that a second insulation layer 26 is disposed on the fire-barrier layer 14 so that the fire-barrier layer 14 is flanked on both sides with an insulation layer 12, 26.

The seventh embodiment shown in FIG. 9 differs from the sixth embodiment shown in FIG. 8 by the fact that the insulation layers 12 and 26 are configured to be much thinner although the construction is principally the same.

The eighth embodiment shown in FIG. 10 differs from the seventh embodiment shown in FIG. 9 by the fact that here an additional fire-barrier layer 14′ is applied onto the outer insulation layer 26, said additional fire-barrier layer being in turn covered with another insulation layer 26′.

In another embodiment that has not been illustrated herein there is still provided a third fire-barrier layer having a fourth insulation layer in order to achieve an even better fire protection.

The ninth embodiment shown in FIG. 11 differs from the first embodiment shown in FIG. 1 by the fact that between the insulation layer 12 and the fire-barrier layer 14 there is provided a layer 28 made from Armaflex.

In another embodiment that has not been illustrated herein, the fire protection system shown in the various figures is mounted to a tray carrying the supply lines.

The FIGS. 12 and 13 show discrete supply lines 110, cables in the present case, onto which an insulation layer 112 made for example from mineral wool is directly applied. A fire-barrier layer forming agent 114 is next mounted to this insulation layer 112 whilst a second insulation layer 126 is provided on the fire-barrier layer forming agent 114. The fire protection system shown in FIG. 12 is configured analogous to the seventh embodiment shown in FIG. 9.

Except for an additional fire-barrier layer 114′ provided on the insulation layer 126, the embodiment shown in FIG. 13 has the same structure as the fire protection system shown in FIG. 12, an additional insulation layer 126′ being provided on said additional fire-barrier layer, in a manner analogous to the eighth embodiment illustrated in FIG. 10.

### LIST OF NUMERALS

10 supply line

12 insulation layer

14, 14′ fire-barrier layer

15 hollow space

16 run

18 tray

20 fire-barrier layer

22 nonwoven glass

24 fire-barrier layer

26, 26′ insulation layer

110 cable

112 insulation layer

114, 114′ fire-barrier layer

126, 126′ insulation layer

1. A fire protection system for two or more supply lines (10), more specifically for supply lines (10) retained on a run (16) or a tray (18), said supply lines (10) being completely surrounded by an insulation layer (12) made from a non-combustible or hardly combustible insulating material and a hollow space (15) being formed between said supply lines (10) and said insulation layer (12),
characterized in
that a fire-barrier layer (14, 24) made from an intumescent fire-barrier layer forming agent is applied to the inside and/or to the outside of said insulation layer (12).

2. (canceled)

3. The fire protection system as set forth in claim 1,
characterized in
that a second insulation layer (26) made from a non-combustible or hardly combustible insulating material is applied to the fire-barrier layer (14) so that the fire-barrier layer forming agent or the ablation is flanked on both sides by insulating material.

4. The fire protection system as set forth in claim 2,
characterized in
that at least one additional fire-barrier layer (20) is applied to the first fire-barrier layer (14).

5. The fire protection system as set forth in claim 4,
characterized in
that the material used in the second fire-barrier layer (20) is different from the one used in the first fire-barrier layer (14).

6. (canceled)

7. The fire protection system as set forth in claim 5,
characterized in
that the insulation layer (12, 26, 112, 126) is at least 10 times, preferably 30 times, the size of the dry coating thickness of the fire-barrier layer (14, 24).

8. The fire protection system as set forth in claim 7,
characterized in
that a non-woven glass (22) or a woven glass fabric is provided between the insulation layer (12) and the fire-barrier layer (14).

9. The fire protection system as set forth in claim 8,
characterized in
that a layer (28) formed from Armaflex is provided between the insulation layer (12) and the fire-barrier layer (14) or on the outside of the fire-barrier layer (14).

10. A fire protection system for two or more supply lines (10), more specifically for supply lines (10) retained on a run (16) or a tray (18), said supply lines (10) being completely surrounded by an insulation layer (12) made from a non-combustible or hardly combustible insulating material and a hollow space (15) being formed between said supply lines (10) and said insulation layer (12),
characterized in
that a fire-barrier layer (14, 24) made from an ablation is applied to the inside and/or to the outside of the insulation layer (12).

11. The fire protection system as set forth in claim 10,
characterized in
that a second insulation layer (26) made from a non-combustible or hardly combustible insulating material is applied to the fire-barrier layer (14) so that the fire-barrier layer forming agent or the ablation is flanked on both sides by insulating material.

12. The fire protection system as set forth in claim 11,
characterized in
that at least one additional fire-barrier layer (20) is applied to the first fire-barrier layer (14).

13. The fire protection system as set forth in claim 12,
characterized in
that the material used in the second fire-barrier layer (20) is different from the one used in the first fire-barrier layer (14).

14. The fire protection system as set forth in claim 13,
characterized in
that the insulation layer (12, 26, 112, 126) is at least 10 times, preferably 30 times, the size of the dry coating thickness of the fire-barrier layer (14, 24).

15. The fire protection system as set forth in claim 14,
characterized in
that a non-woven glass (22) or a woven glass fabric is provided between the insulation layer (12) and the fire-barrier layer (14).

16. The fire protection system as set forth in claim 15,
characterized in
that a layer (28) formed from Armaflex is provided between the insulation layer (12) and the fire-barrier layer (14) or on the outside of the fire-barrier layer (14).

17. A fire protection system for one supply line (110), said supply line (110) being completely surrounded by an insulation layer (112) made from a non-combustible or hardly combustible insulating material, a fire-barrier layer (114) made from an intumescent fire-barrier layer forming agent or from an ablation being applied to the outside of said insulation layer (112),
characterized in
that a second insulation layer (126) made from a non-combustible or hardly combustible insulating material is applied to the fire-barrier layer (114) so that the fire-barrier layer forming agent or the ablation is flanked on both sides by insulating material.

18. The fire protection system as set forth in claim 17,
characterized in
that the insulation layer (12, 26, 112, 126) is at least 10 times, preferably 30 times, the size of the dry coating thickness of the fire-barrier layer (14, 24).

19. The fire protection system as set forth in claim 18,
characterized in
that a non-woven glass (22) or a woven glass fabric is provided between the insulation layer (12) and the fire-barrier layer (14).

20. The fire protection system as set forth in claim 19,
characterized in
that a layer (28) formed from Armaflex is provided between the insulation layer (12) and the fire-barrier layer (14) or on the outside of the fire-barrier layer (14).
